(19) United States
(12) Patent Application Publication
(10) Pub. No.: US 2026/0133738 A1
(43) Pub. Date: May 14, 2026

(54) IMAGE ADJUSTMENT METHOD AND RELATED IMAGE DISPLAYING APPARATUS

(71) Applicant: MEDIATEK INC., Hsinchu City (TW)

(72) Inventors: Chien-Chun Sung, Hsinchu City (TW); Cheng-Chieh Chen, Hsinchu City (TW); Kuo-Chen Huang, Hsinchu City (TW); Chin-Wen Liang, Hsinchu City (TW)

(73) Assignee: MEDIATEK INC., Hsinchu City (TW)

(21) Appl. No.: 18/946,790

(22) Filed: Nov. 13, 2024

(51) Int. Cl. G06F 3/14

(52) U.S. Cl. CPC G06F 3/1407

(57) ABSTRACT

An image adjustment method is applied to an image displaying apparatus and includes analyzing an image stream with a plurality of received frames, determining whether a region of one of the received frames conforms to an execution requirement of a non-partial update function, and applying the non-partial update function or a partial update function for the received frame in accordance with a determination result.

### BACKGROUND

A conventional display device has a global update function and a partial update function; all pixels on the display device are affected by the global update function, and pixels that need to be changed on the display device are affected by the partial update function for rapid update requirement. The conventional display device determines whether an image frame conforms to a preset condition for the global update function, and executes the global update function when the image frame conforms to the preset condition for the global update function, or executes the partial update function when the image frame does not conform to the preset condition for the global update function. Therefore, there is a need for the conventional display device determining whether to actuate the partial update function in a better way.

### SUMMARY

The present invention provides an image adjustment method and an image displaying apparatus of both supporting the PQ function and the PU function for solving above drawbacks.

According to the claimed invention, an image adjustment method is applied to an image displaying apparatus and includes analyzing an image stream with a plurality of received frames, determining whether a region of one of the received frames conforms to an execution requirement of a non-partial update function, and applying the non-partial update function or a partial update function for the received frame in accordance with a determination result.

According to the claimed invention, the image adjustment method further includes applying the non-partial update function for the received frame in accordance with a specific parameter of the received frame when the region conforms to the execution requirement, or applying the non-partial update function for the received frame in accordance with a current status of the image displaying apparatus when the region conforms to the execution requirement.

According to the claimed invention, the image adjustment method determines whether the region of one of the received frames conforms to an execution requirement of any of non-partial update functions, and applies a corresponding non-partial update function when the region conforms to the execution requirement. The image adjustment method further includes not applying the partial update function for the received frame when the non-partial update function is applied to the region. The image adjustment method further includes applying the partial update function for the received frame when the region does not conform to the execution requirement.

According to the claimed invention, the specific parameter is based on a software setting result, and the current status is a detection result of a sensor of the image displaying apparatus. The received frame is divided into a plurality of regions in a uniform manner or in a non-uniform manner. The image adjustment method further includes determining whether the region of the received frame conforms to the execution requirement of the non-partial update function every N received frames or every predefined time.

According to the claimed invention, an image displaying apparatus includes an operation processor adapted to analyze an image stream with a plurality of received frames, determine whether a region of one of the received frames conforms to an execution requirement of a non-partial update function, and apply the non-partial update function or a partial update function for the received frame in accordance with a determination result.

The image adjustment method and the image displaying apparatus of the present invention can have both the PQ function and the PU function, and can decide how to dynamically switch between the PQ function and the PU function in accordance with the analysis result of the received frame in the image stream. Comparing to the prior art of directly excluding the PQ function and only executing in the process of the PU function, the image adjustment method and the image displaying apparatus of the present invention can support various types of the PQ function, and do not exclude the specific PQ function in the process of the PU function, thereby achieving an aim of being relatively switched between the PQ function and the PQ function.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image displaying apparatus according to an embodiment of the present invention.

FIG. 2 is a flow chart of an image adjustment method according to the embodiment of the present invention.

FIG. 3 is a functional block diagram of an PU arbitrator according to the embodiment of the present invention.

FIG. 4 and FIG. 5 are diagrams of the received frame in different image adjustment modes according to different embodiments of the present invention.

FIG. 6 is a diagram of the PQ function and the PU function in state transition according to the embodiment of the present invention.

### DETAILED DESCRIPTION

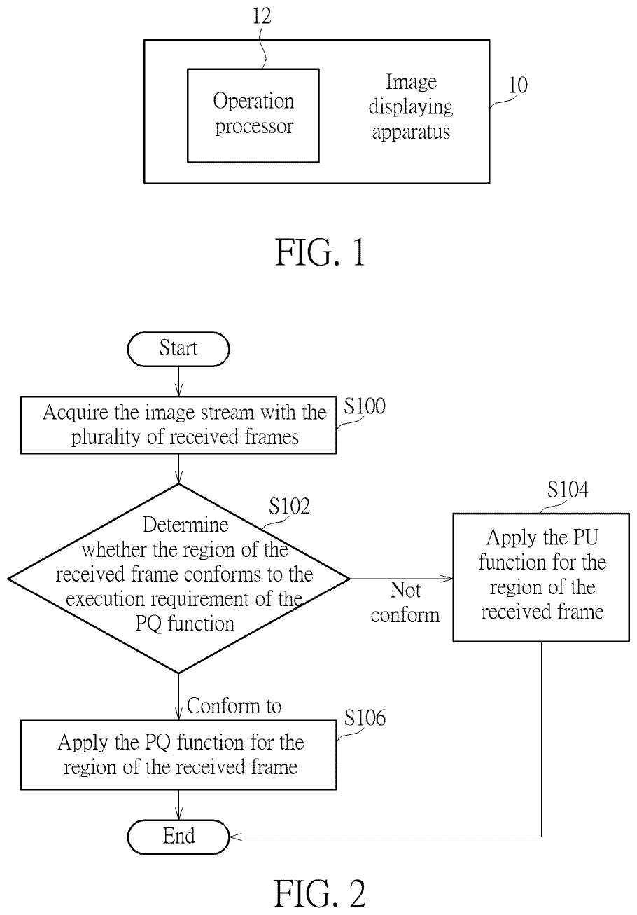

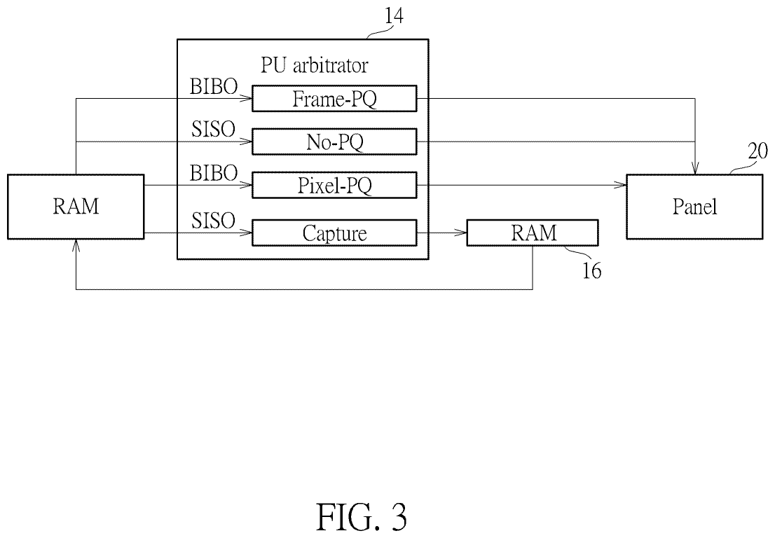

Please refer to FIG. 1 and FIG. 2. FIG. 1 is a functional block diagram of an image displaying apparatus 10 according to an embodiment of the present invention. FIG. 2 is a flow chart of an image adjustment method according to the embodiment of the present invention. The image displaying apparatus 10 can be applied to any apparatus with a displaying function, and can dynamically analyze one or some received frames of an image stream, and actively vary a support capability of a partial update function (which is defined as PU function in the following statement) in accordance with a non-partial update function (which is defined as PQ function in the following statement) of the image frame. In some embodiments, PQ function indicates the function to adjust at least one parameter for display or any other function to adjust picture quality for displaying partial or global content. An operation processor 12 of the image displaying apparatus 10 can execute the image adjustment method illustrated in FIG. 2, and has both the PQ function and the PU function, thereby utilizing the multiple PQ functions in the entire scene to maximize the use of the PU function.

According to the image adjustment method, step S100 and step S102 can be executed to acquire the image stream with the plurality of received frames, and determine whether a region of one received frame conforms to an execution requirement of the PQ function. In step S102, the received frame may optionally include a plurality of regions in a uniform manner or in a non-uniform manner, and the image adjustment method of the present invention can respectively determine whether all the plurality of regions conforms to the execution requirement of the PQ function; practical application of distribution of the region is not limited to the foresaid embodiments, and depends on a design demand. In possible embodiment of the present invention, the image adjustment method can execute step S102 for each received frame of the image stream, or can execute step S102 every N received frames of the image stream, or can execute step S102 every predefined time for the image stream, or can intermittently acquire the received frame according to a specific detection result of a sensor for executing step S102; execution variation of step 102 can depend on the design demand.

In the present invention, the foresaid PQ functions can at least include the no-PQ function, the frame-based PQ function, the block-bases PQ function, and the pixel-based PQ function; a type of the PQ function is not limited to the foresaid embodiments, and functional features of the foresaid PQ functions can be common sense and therefore a detailed description is omitted herein for simplicity. The image adjustment method of the present invention can at least support the above four PQ functions to maximize the use of PU function. On the contrary, the prior art cannot support the frame-based PQ function and the block-based PQ function with the PU function.

When the region of the received frame does not conform to the execution requirement, step S104 can be executed to apply the PU function for the region of the received frame. When the region of the received frame conforms to the execution requirement, step S106 can be executed to apply the PQ function for the region of the received frame in accordance with a specific parameter of the received frame and/or a current status of the image displaying apparatus 10. In the present invention, the received frame may be suitable for the multiple PQ functions; for the image adjustment method, a priority level of the PQ function can be higher than a priority level of the PU function, which means the PU function can be executed only when the received frame does not meet any execution requirement of the PQ functions. Relatively, as long as the received frame meets the execution requirement of any of the PQ functions, the received frame can be processed in accordance with the type of PQ function, and the image adjustment method does not apply the PU function for the received frame at the same time. In some embodiments, once the determination mentioned in step 102 is performed, and then no determination mentioned in step 102 will be performed for the following N−1 received frames of the image stream, such that step 104 or step 106 will be executed for the following N−1 received frames of the image stream based on the same determination result. In some embodiments, if one or more PQ requests are made during the following N−1 received frames of the image stream, step 104 or step 106 will be executed based on the same determination result. In some other embodiments, if one or more PQ requests are made during the following N−1 received frames of the image stream, step 104 or step 106 will be interrupted and go to step 102. In some embodiments, the one or more PQ requests are made to adjust or change the setting or parameters of ongoing PQ function for displaying partial or global content.

In addition, each received frame of the image stream can have the preset PQ function, which may be recorded in the received frame via the specific parameter; the image adjustment method of the present invention can analyze the specific parameter of the received frame to decide which kind of the PQ functions to be applied for the received frame. The specific parameter may be automatically or manually set by software of the image displaying apparatus 10. Besides, the image displaying apparatus 10 can include a specific sensor (such as an ambient sensor and is not shown in the figures), and the image adjustment method of the present invention can acquire the current status of the image displaying apparatus 10 based on a detection result of the specific sensor (for example, determining whether it meets the status of the sunlight mode), so as to decide which kind of the PQ functions to be applied. In some embodiments, the specific sensor may be an ambient light for determining if there is any PQ request needed due to ambient light status being different. In some other embodiments, the current status of the image displaying apparatus 10 may include any status change of the image displaying apparatus 10 which leads to signaling at least one PQ request, where such status change may include change of backlight setting of the image displaying apparatus 10, brightness change caused by content histogram showing on the image displaying apparatus 10 or any other status change of the image displaying apparatus 10. The present invention is not limited to the foresaid two embodiments as to how to decide which PQ function can be applied to the received frame, and other possible embodiment is omitted herein for simplicity.

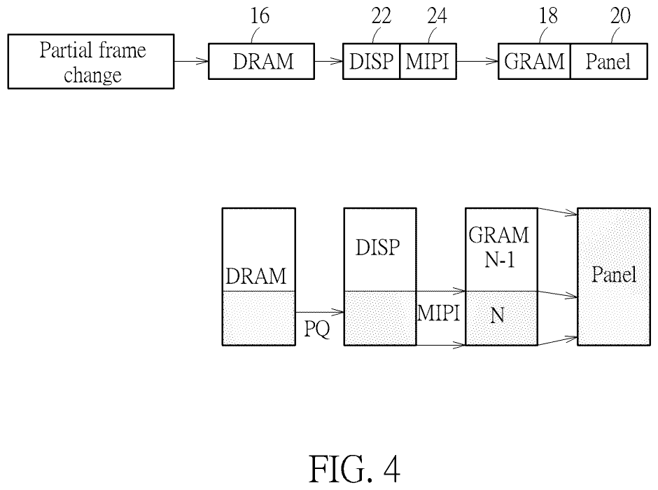

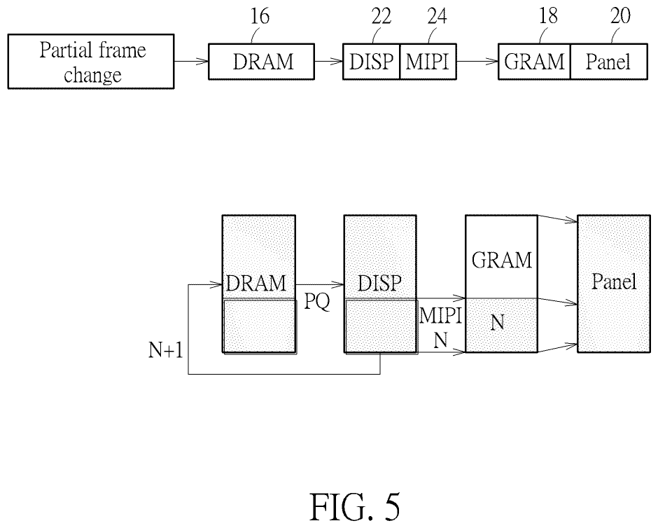

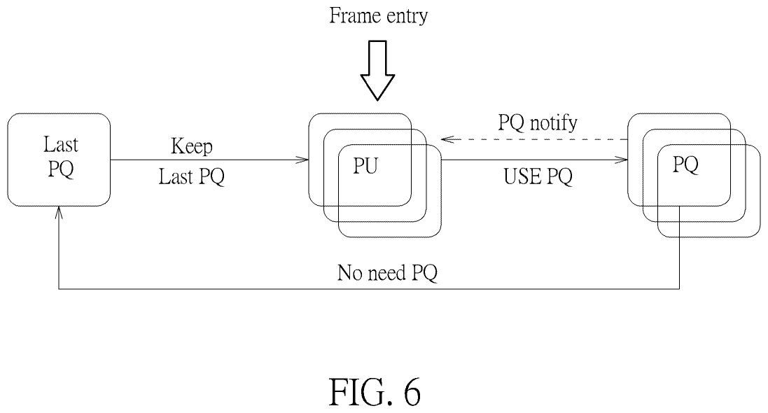

Please refer to FIG. 3 to FIG. 6. FIG. 3 is a functional block diagram of an PU arbitrator 14 according to the embodiment of the present invention. FIG. 4 and FIG. 5 are diagrams of the received frame in different image adjustment modes according to different embodiments of the present invention. FIG. 6 is a diagram of the PQ function and the PU function in state transition according to the embodiment of the present invention. A random-access memory (RAM) can be disposed on a front end of the PU arbitrator 14, and another random-access memory 16 (such as the DRAM) can be disposed on a rear end of the PU arbitrator 14. The situation shown in FIG. 4 may be the small in and small out (SISO) type suitable for the no-PQ function (such as a symbol “No-PQ”) and the pixel-based function (such as a symbol “Pixel-PQ”); when the partial frame changes, the RAM 16 can only update the region (such as a grid pattern) of the received frame (which is a rectangular frame greater than the grid pattern), and the foresaid region can be transmitted towards the DISP 22 (such as the display) for process of the PQ function; meanwhile, this processing stage is still in the application program/application processor (AP). Then, the processed data of the DISP 22 can be transmitted towards the RAM 18 of the panel 20 via the MIPI 24 (or any applicable signal transmission interface). The RAM 18 (such as the GRAM) can record the previous received frame in this processing stage and only update some part of the received frame, but can transmit the whole received frame towards the panel 20; that is to say, the RAM 18 can keep the data of the previous received frame in the upper half of the screen (such as an area marked as a symbol “N−1”), and provide the data of the following received frame in the lower half of the screen (such as an area marked as a symbol “N”).

The situation shown in FIG. 5 may be the big in and small out (BISO) type suitable for the capture mode (such as a symbol “Capture”); when the partial frame changes, the RAM 16 may update the whole received frame (such as the grid pattern) for acquiring or extracting statistic data of the received frame (such as the histogram). Then, the RAM 16 can transmit the whole received frame towards the DISP 22 for process of the PQ function, and the DISP 22 can transmit the part of the received frame (such as the grid pattern) towards the RAM 18 of the panel 20 via the MIPI 24. This situation can acquire or extract the statistic data (such the histogram) of the received frame, and the statistic data of the whole received frame (such as a symbol “N”) can be the feedback for the following received frame; for example, an intensity or other parameter of the following received frame (such as a symbol “N+1”) can be changed accordingly. It should be mentioned that the processed data which has not yet reached the panel 20 can be directly sent back to the front end RAM from the RAM 16, and will not send to the panel 20.

In some embodiments for the practical applications, when the image displaying apparatus 10 is moved to the outdoor place and needs to apply the PQ function, the image adjustment method of the present invention can decide the state transition between the PU function and the PQ function based on the current received frame (or the statistic data of the previous received frame); this stage can indicate that the received frame is preset to suit the PU function, and can be switched into the PQ function in accordance with the symbol “PQ notify”. When the received frame is switched into the PQ function, the parameter (such as the symbol “Last PQ”) of the previous received frame in the PQ function can be kept in a condition of not using the PQ function (such as the symbol “No Need PQ”); the execution parameter of the PQ function from the previous received frame can be inherited during the execution stage of the PU function.

As shown in FIG. 3, the frame-PQ mode, the No-PQ mode, the pixel-PQ mode and the capture mode can be set in a hybrid mode. For example, if the received frame is assumed to suit the pixel-PQ mode (or the No-PQ mode) and the capture mode, the image adjustment method of the present invention can provide the BISO ability of the capture mode after analysis and process of the received frame; if the received frame is assumed to suit the frame-PQ mode and the capture mode, the image adjustment method of the present invention can provide the BIBO ability after analysis and process of the received frame.

In conclusion, the image adjustment method and the image displaying apparatus of the present invention can have both the PQ function and the PU function, and can decide how to dynamically switch between the PQ function and the PU function in accordance with the analysis result of the received frame in the image stream. As a result, the image adjustment method and the image displaying apparatus of the present invention can support various types of the PQ function, and do not exclude the specific PQ function in the process of the PU function, thereby achieving an aim of being relatively switched between the PQ function and the PQ function.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image adjustment method applied to an image displaying apparatus, the image adjustment method comprising:
analyzing an image stream with a plurality of received frames;
determining whether a region of one of the received frames conforms to an execution requirement of a non-partial update function; and
applying the non-partial update function or a partial update function for the received frame in accordance with a determination result.

2. The image adjustment method of claim 1, further comprising:
applying the non-partial update function for the received frame in accordance with a specific parameter of the received frame when the region conforms to the execution requirement.

3. The image adjustment method of claim 1, further comprising:
applying the non-partial update function for the received frame in accordance with a current status of the image displaying apparatus when the region conforms to the execution requirement.

4. The image adjustment method of claim 1, wherein the image adjustment method determines whether the region of one of the received frames conforms to an execution requirement of any of non-partial update functions, and applies a corresponding non-partial update function when the region conforms to the execution requirement.

5. The image adjustment method of claim 2, further comprising:
the image adjustment method does not apply the partial update function for the received frame when the non-partial update function is applied to the region.

6. The image adjustment method of claim 1, further comprising:
applying the partial update function for the received frame when the region does not conform to the execution requirement.

7. The image adjustment method of claim 2, wherein the specific parameter is based on a software setting result.

8. The image adjustment method of claim 3, wherein the current status is a detection result of a sensor of the image displaying apparatus.

9. The image adjustment method of claim 1, wherein the received frame is divided into a plurality of regions in a uniform manner or in a non-uniform manner.

10. The image adjustment method of claim 1, further comprising:
determining whether the region of the received frame conforms to the execution requirement of the non-partial update function every N received frames or every predefined time.

11. An image displaying apparatus, comprising:
an operation processor adapted to analyze an image stream with a plurality of received frames, determine whether a region of one of the received frames conforms to an execution requirement of a non-partial update function, and apply the non-partial update function or a partial update function for the received frame in accordance with a determination result.

12. The image displaying apparatus of claim 11, wherein the operation processor is adapted to further apply the non-partial update function for the received frame in accordance with a specific parameter of the received frame when the region conforms to the execution requirement.

13. The image displaying apparatus of claim 11, wherein the operation processor is adapted to further apply the non-partial update function for the received frame in accordance with a current status of the image displaying apparatus when the region conforms to the execution requirement.

14. The image displaying apparatus of claim 11, wherein the image adjustment method determines whether the region of one of the received frames conforms to an execution requirement of any of non-partial update functions, and applies a corresponding non-partial update function when the region conforms to the execution requirement.

15. The image displaying apparatus of claim 12, wherein the operation processor is adapted to further not apply the partial update function for the received frame when the non-partial update function is applied to the region.

16. The image displaying apparatus of claim 11, wherein the operation processor is adapted to further apply the partial update function for the received frame when the region does not conform to the execution requirement.

17. The image displaying apparatus of claim 12, wherein the specific parameter is based on a software setting result.

18. The image displaying apparatus of claim 13, wherein the current status is an automatic detection result of a sensor of the image displaying apparatus.

19. The image displaying apparatus of claim 11, wherein the received frame is divided into a plurality of regions in a uniform manner or in a non-uniform manner.

20. The image displaying apparatus of claim 11, wherein the operation processor is adapted to further determine whether the region of the received frame conforms to the execution requirement of the non-partial update function every N received frames or every predefined time.
